(19) United States
(12) Patent Application Publication
(10) Pub. No.: US 2011/0046910 A1
(43) Pub. Date: Feb. 24, 2011

(54) Method and System for Sample Testing

(75) Inventors: Hansjoerg W. Haas, Burlington (CA); Roger B. Hertz, Burlington (CA); Susan Hertz, Burlington (CA); Brian W. Daniels, Weston (CA); James R. Ladine, Uxbridge, MA (US); Andreas L. Stelzer, Toronto (CA); Blair D. Leduc, Mount Hope (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THERMO CRS LTD.

(21) Appl. No.: 11/918,218

(22) PCT Filed: Feb. 1, 2006
(86) PCT No.: PCT/CA2006/000122

§ 371 Date: Mar. 24, 2010

(30) Foreign Application Priority Data
Apr. 15, 2005 (US) PCT CA2005 000567

(51) Int. Cl. G01N 35/00; G06F 19/00

(52) U.S. Cl. 702/108

(57) ABSTRACT

The invention provides a system and method for testing samples and, in one embodiment, a system for directing and coordinating the operations of hardware components and performance of tasks of laboratory personnel. The system includes a user interface for receiving requests from one or more users. Each request comprises a list of one or more samples to be tested and specifies one or more tests to be conducted on each sample. The system also includes a sample preparation station for maintaining a library of all received samples and creating a sublibrary of samples based on the test(s) to be conducted. The system directs hardware components and laboratory personnel (collectively, laboratory resources) to conduct the requested tests and reports test results to the user(s) who have requested the test(s).

### CROSS-REFERENCE TO RELATED APPLICATIONS

This is a continuation-in-part application of International Application No. PCT/CA2005/000567, filed Apr. 15, 2004, which claims priority from U.S. Provisional Application No. 60/562,851 and U.S. Provisional Application No. 60/648,225, each of which is incorporated herein by reference in its entirety.

### FIELD OF THE INVENTION

The invention relates generally to the field of task management. In particular, the invention relates to an integrated system and method for orchestrating the testing of samples.

### BACKGROUND OF THE INVENTION

Testing of samples, especially chemical testing for screening compounds that satisfy certain properties, often requires a large number of tests. Often, a large number of samples are involved. Each sample may require several tests or assays to be conducted thereon. Test results in one test sometimes may determine whether subsequent tests will be required. For example, as is often the case, only a small number of screened compounds can meet the selection criteria. Current laboratory processes are not ideally suited for such screening processes. Some of these reasons are as follows:

1) Large number of assays: Typically the screening process requires a number of assays to be run on candidate compounds, to test for various properties.

2) Time consuming assays/tests: Many assays such as liquid chromatography mass spectrometer etc. typically require extensive time for processing samples and acquiring data and are therefore rate limiting steps.

3) Data Quality: The results from the tests need to be of high quality in order to allow for well-informed decisions. The analytical confidence in prior art methods may be low because of discontinuous steps in experimentation, and because data was obtained by different groups.

4) Capital Intensive Equipment: The equipment necessary to perform certain assays is very capital intensive. Many large organizations have numerous labs in one or more locations. As such, the requirement for multiple equipment or instrumentation further increases these costs.

In addition to the above issues, it is known to run the various assays in parallel as opposed to a serial manner. In the serial approach, the assays are linked successively with a pre-set selection criteria. Thus, a particular test will be conducted if a prior test result provides an acceptable result. The parallel approach comprises running multiple assays simultaneously. Although the latter approach may save time, it results in additional expense since tests are conducted on various compounds that may have been withdrawn from consideration for other reasons (i.e. due to failure of another assay etc.).

The foregoing creates challenges and constraints for a method and system for screening drugs. It is an object of the present invention to mitigate or obviate at least one of the above mentioned disadvantages.

### SUMMARY OF INVENTION

The invention provides a system and method for testing samples and, in one embodiment, a system for directing and coordinating the operations of hardware components and performance of tasks of laboratory personnel. The system includes a user interface for receiving requests from one or more users. Each request comprises a list of one or more samples to be tested and specifies one or more tests to be conducted on each sample. The system also includes a sample preparation station for maintaining a library of all received samples and creating a sublibrary of samples based on the test(s) to be conducted. The system directs hardware components and laboratory personnel (collectively, laboratory resources) to conduct the requested tests and reports test results to the user(s) who have requested the test(s).

Optionally, the user can specify, in the request, a test strategy to conduct tests in parallel, in series, or a combination thereof. The test strategy can also include branching conditions to specify the parameters for promoting a sample on to subsequent tests or which subsequent tests to conduct depending on the results of prior tests. The system may generate an order for conducting the tests based on the test strategy and/or branching conditions specified and direct laboratory resources to conduct each requested test following the order generated.

In another feature, the system permits dynamic preparation of sublibraries. For example, upon completion of a given test on a given sample, the system may direct the sample preparation station to create a further sublibrary, including such sample, for a subsequent test. In this way, sublibraries are created including only those samples that are promoted for further testing. In one aspect, the creation of the further sublibrary can be started as soon as one sample from the previous sublibrary is ready to be promoted. In this way, sublibraries can be generated dynamically in response to test results of individual samples without waiting for all samples or a sublibrary to be tested.

In other aspects the invention provides various combinations and subsets of the aspects described above.

### BRIEF DESCRIPTION OF DRAWINGS

For the purposes of description, but not of limitation, the foregoing and other aspects of invention are explained in greater detail with reference to the accompanying drawings, in which:

FIG. 1 shows schematically major components of an orchestrated laboratory system and their organization within the system;

FIG. 2 illustrates schematically a reformatter for use in the orchestrated laboratory system shown in FIG. 1;

FIG. 3 shows schematically an assay station for use in the orchestrated laboratory system shown in FIG. 1;

FIG. 4 provides an overview of a software system, i.e., the software portion of the system of FIG. 1;

FIG. 5 shows an exemplary screen display that a user of the system of FIG. 1 can use to define a screening process;

FIG. 5A shows another exemplary screen display that a user of the system of FIG. 1 can use to define a screening process;

FIG. 6 illustrates a orchestrated testing environment supported by the system shown in FIG. 1;

FIG. 7 shows schematically a laboratory workflow employed in the system shown in FIG. 1;

FIG. 8 illustrates a test strategy that runs a combination of parallel and serial tests;

FIG. 9 shows an exemplary screen display for a user to confirm or modify a decision whether to promote a compound for conducting another test;

FIG. 10 is a flow chart of an orchestrated laboratory process that is implemented by the system shown in FIG. 4;

FIG. 11A is an exemplary screen display that provides detailed status and summary information related to a user request;

FIG. 11B is an exemplary screen display showing more detailed information when a user selects an actuatable area of the screen shown in FIG. 11A;

FIG. 12 shows an exemplary testing time allocation followed by the software system shown in FIG. 4;

FIG. 13A illustrates schematically a process of performing an assay in the orchestrated testing environment shown in FIG. 6; and

FIG. 13B shows steps of the process of FIG. 13A in a flowchart format.

### DETAILED DESCRIPTION OF THE INVENTION

The description which follows and the embodiments described therein are provided by way of illustration of an example, or examples, of particular embodiments of the principles of the present invention. These examples are provided for the purposes of explanation, and not limitation, of those principles and of the invention. In the description which follows, like parts are marked throughout the specification and the drawings with the same respective reference numerals.

In one aspect, the present invention relates to a system and method for the orchestration of testing samples. Although the example of chemical or drug testing is used to illustrate the invention, it will be understood that the invention is not limited to such application and may be equally used for any other purposes such as stress testing or nondestructive testing of finished products in a quality control procedure. In general, the invention can be adapted to coordinate or orchestrate any testing protocol.

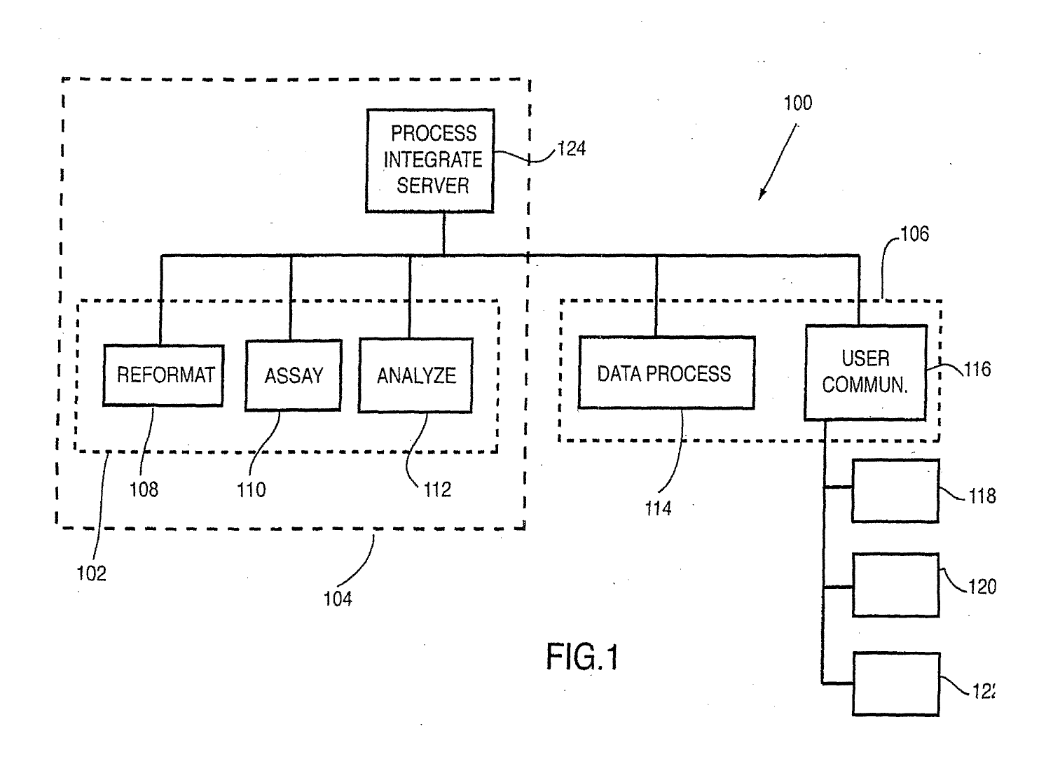

In the embodiment of the invention described herein, examples of chemical testing are provided wherein chemical samples are deposited tested using commonly known microtitre plates. Such plates are transported to the test or assay station, which includes the required equipment, apparatus or personnel for conducting the desired test or assay. FIG. 1 shows schematically the architecture of an orchestrated laboratory system 100, including a number of hardware components. Each hardware component may have its own automation software. Conceptually, orchestrated laboratory system 100 may be considered to consist of hardware, laboratory personnel, automation software and communication components and all infrastructure, equipment, software, etc. required to operate such components. The operation of these components, including the performance of tasks by laboratory personnel are orchestrated by a central process integration server.

FIG. 1 shows hardware components 102, software components 104 and Communication components 106 of system 100. The hardware components 102 provides hardware resources such as workstations for performing the various experiment processes required by the system. The coordination of operations and processes between the hardware components is provided by software components 104, which may also coordinate execution of laboratory functions. Laboratory personnel may interact with the software and the hardware components to provide, where necessary, the operational support and equipment management. The communication components 106 coordinate information flow and processing of data, including, for example, data processing, storage and retrieval, as well as user communication. The hardware components may have multiple basic units, each of which can be combined for parallelization of processes, utilizing a common container/carrier for the samples. The modular design of system 100 permits the addition of further hardware components as necessary or desirable, or substituting of existing components.

By way of example, FIG. 1 shows three hardware components. However, as explained above, the system 100 is not restricted to these three hardware components. In fact, the hardware, although shown and conceptually divided into different components, may all be enclosed in one enclosure and may share physical platforms or spaces when conducting experiments or performing sample preparation or analysis. The hardware components shown in FIG. 1 may, for example, include a sample preparation station such as a reformatter 108 for preparing samples for each requested assay, an assay station 110 for conducting assays and collecting data obtained from such assays, and an analyzer station 112 for analyzing samples and collecting data from such analysis.

The communication components include a data processing module 114 for processing and analyzing data obtained from the various tests and coordinating the flow of data through the system as will be described in greater detail below. The user communication subsystem 116 provides services allowing a user to interact with the system. Users of the system may be scientists, laboratory technicians, facility staff or other department or institution personnel. In general, a user may be anyone that interfaces with the system to conduct tests on samples or access test data. This will assume that the users have any required security clearances to access the system. The user communication subsystem 116 may also include a display terminal 118 for providing system status information, such as availability of hardware resources, status of experiments, test results or other relevant information to a user. The system may also include an administration workstation 120, allowing a user to interact with the system, so that the user may, for example, control the operation of the system, the workflow executed by the system, or monitor the progress of various experiments performed by the hardware resources. In addition, the system may also provide remote access to a user in the form of an information portal 122. The information portal 122 provides the remote display of a user interface that provides a user with status and other information and allows a user to access the system using the user's own computer resources. User's own computer resources may include a computer workstation, a terminal, or a handheld computer, among others, which may or may not have the same operating system used by the user communication subsystem 116.

The software components 104 include a process integration server 124, which coordinates and orchestrates the operation of laboratory resources including hardware components and/or laboratory personnel. The software components may also include various instrument automation components. For each hardware component, there can be provided a corresponding software component for the automation and control thereof. There can also be a corresponding data acquisition module for each of the hardware components for acquiring data for the test conducted and coordinating the data flow.

As will be described below, the software components 104 also may include a scheduler (not shown in FIG. 1) that determines an order to run each of the experiments according to test plans or criteria provided by users.

Generally, when requesting testing of a sample, the user provides the sample to a laboratory, for conducting planned tests. Samples provided by users are maintained in a sample library. Sublibraries of samples are then prepared, based on the tests to be conducted. That is, one or more samples on which a given test is to be conducted are grouped into a sublibrary. In a preferred embodiment, each sublibrary may comprise samples on one or more microtitre plates as known in the art. The wells of such plates contain a volume of the desired samples. As will be appreciated by persons skilled in the art, microtitre plates are designed with an array of wells (each adapted to receive a small volume of sample). In the result, the location of each sample on the plate can be specifically assigned, or mapped, to a particular well. This facilitates the tracking of a sample as it passes through required testing steps. This is further described below.

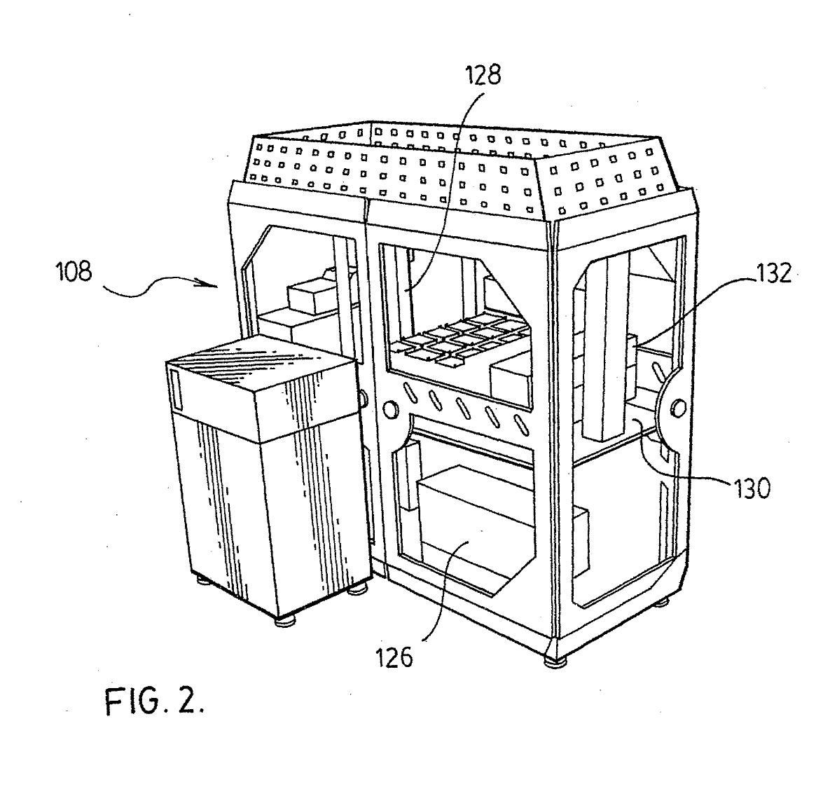

FIG. 2 illustrates schematically a reformatter 108 that stores the sample library and creates any needed sublibraries. Typically, a reformatter 108 includes robotic control and automation devices, liquid handling devices, sample storage unit and sample processing unit. These main components provide the necessary functions of sample preparation and processing, namely, preparation and processing of samples for experiments from a pool of samples, such as a sample library, and creation of a sublibrary (“reformatting”), including plate replication, dilutions, additions, sealing and labeling, among others.

The reformatter 108 shown in FIG. 2 may be provided with a controlled environment space, such as a refrigerated incubator or a refrigerated storage 126, for storing samples. Robotic plate handling devices, such as robot arm 128, facilitate automated plate handling, and in particular, provide the capability of moving automatically a sample plate from refrigerated storage 126 to different locations, such as a lid park (not shown) for de-lidding, or a deck or plate platform 130 of liquid handler 132 for further liquid handling. Liquid handler 132 enables the system to replicate these plates when needed. Liquid handler 132 in general automates liquid handling such as reagent addition, dilution, transfer and dispensing.

The plates used in the system are uniquely identified so that the location and status of each plates can be determined, preferably in real time. To accomplish this, each plate may be provided with an identification device such as a bar code label or RF (radio frequency) chip etc. Various other devices will be known too. In conjunction with such identification devices. The various stations of the system (including reformatter etc.) may include a reader to read the identification device and to identify, the plates. Such readers can also be connected to the process integration server so that the location and/or status of each plate can be tracked and monitored. As mentioned above, each sample well on a plate can be specifically mapped. Thus, by tracking each plate, specific information concerning such sample may be tracked.

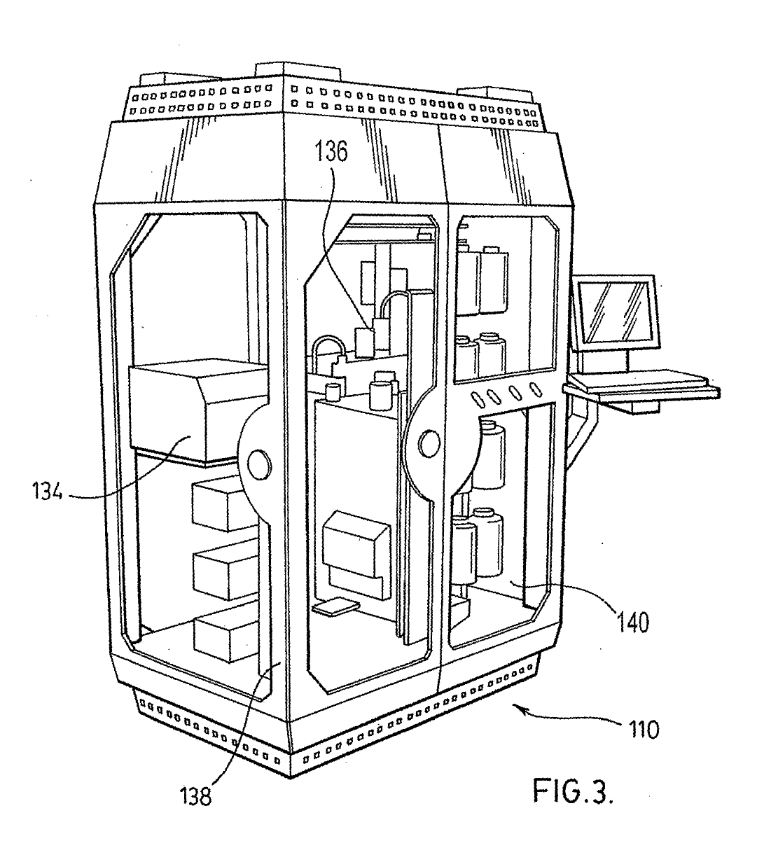

FIG. 3 shows schematically an assay station 110. In general, assay station 110 may be a multifunctional workcell that is capable of conducting one or more experiments. The assay station 110 may preferably include one or more movers 134 to relocate microtitre plates to different instruments/stations 136 within the cell. Movers 134 may comprise robotic devices to minimize human intervention. An assay station 110 may have its own liquid handlers (not shown) to supplement the needs of, for example, reagent dilution, transfer and dispensing while experiments are conducted within the unit. The assay station preferably also may include plate identification means (such as the readers mentioned above). The assay station 110 may also have other laboratory process accessories, such as components for maintaining temperature of the samples or for providing agitation of sample plate holders etc.

Assay station 110 is preferably enclosed for safety, reliability and protection from the external environment. FIG. 3 shows an example of an enclosure shell 138, with transparent windows 140 for easy monitoring. Assay station 110 is designed to have a minimized footprint by maximizing the utilizable space. Preferably, assay station 110 is self-contained and small enough to be easily relocated.

An analyzer station 112 may be provided for analyzing the test results and collecting experimental data. For example, analyzer station 112 may be a high throughput liquid chromatography mass spectrometry (LC-MS) workstation. Such a workstation enables its users to automatically analyze a large number of microtitre plate samples at high speed with LC-MS technology. Samples from microtitre plates may be injected at random into an LC-MS at high speeds. Instruments such as an automated incubator (controlled environment) can also be used to supply these plates at random with high speed to an auto-sampler (not shown) that will inject samples into an LC-MS workstation. A data acquisition unit (not shown) connected to analyzer station 112 captures data generated by, analyzer station 112, such as a high throughput LC-MS workstation, and transmits the captured data to process integration server 124 for further processing.

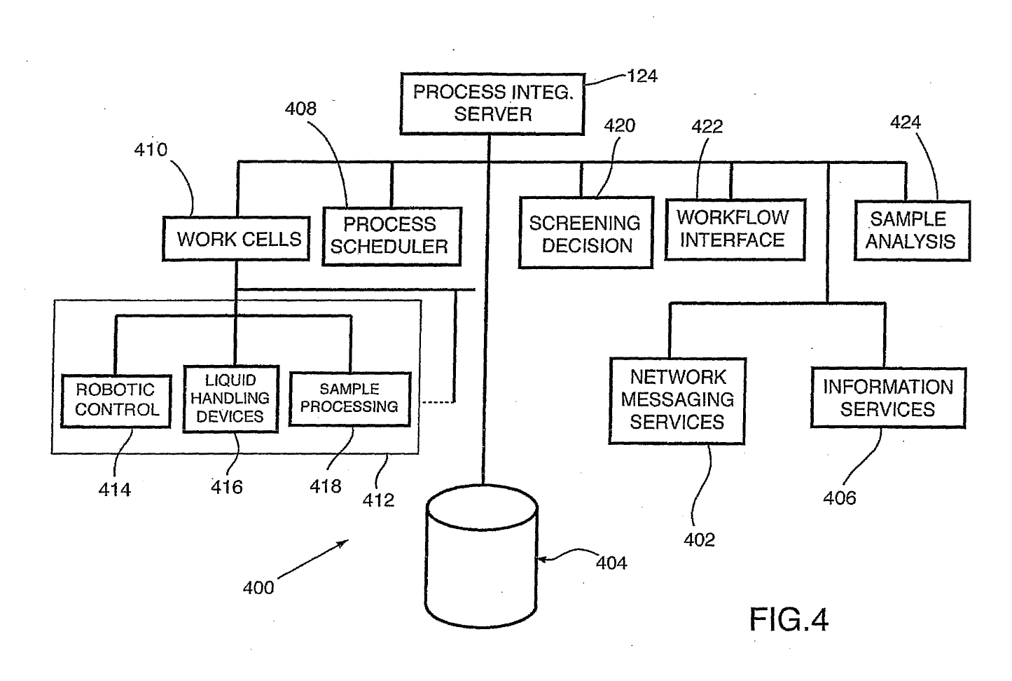

FIG. 4 provides an overview of a software system 400, i.e., the automation software portion and IT software portion of the system 100 in more detail. The software system 400 provides the control and integration of the operation of hardware components and the testing processes utilizing these hardware components. Among other things, the software system 400 coordinates and manages laboratory workflow, directs laboratory resources to initiate assays requested by researchers, tracks and manages data to facilitate monitoring of workflows, receives and processes user requests and reports to users upon completion of requested testing. Necessary data processing capability and user control as well as means for communication between a user and the system 400, and between the hardware components and the software system 400, are also provided.

The software system 400 has a number of components to provide its functionality. The process integration server 124 provides the function of orchestration. Other components may include network messaging module 402, data warehouse 404, information services module 406, process scheduler 408, instrument cell subsystem 410 for each of the reformatter 108, assay station 110 and analyzer station 112, decision module 420, workflow interface subsystem 422 and analytics module 424.

In general, messages are generated and exchanged for establishing communication between and among the process integration server 124 and various data processing and logic process units. For example, the network messaging module 402 exchanges messages with various hardware subsystems to control start, stop, operations of the hardware, data collection, and to monitor hardware subsystems. The network messaging module 402 also exchanges messages with user communication subsystem 116 for receiving inputs from and communicating output to users. These messages may be in the form of any network messages conforming to a suitable protocol or protocols, such as web service messages in http (hypertext transfer protocol) format, or electronic control signals if a hardware unit is directly controllable by software system 400.

Data warehouse 404 is a data depository Data warehouse 404 may consist of one database or several integrated databases, stored on one storage medium, or several different storage media, or any suitable storage or memory means. Data warehouse 404 stores data as acquired from each workcell during experiments or upon completion of experiments. A complete audit trail of each experiment may be collected at each hardware unit and archived in data warehouse 404. Such audit data may include, for example, the location of a sample and the time the sample stayed at that location, the test conditions of an experiment conducted on a sample at a workstation, status information of a hardware unit when conducting an experiment, among others. Processed data, i.e., data generated from a data analysis operation on raw data, are also stored in data warehouse 404. For easy storage and retrieval as well as for access control, the database may be a secure SQL database. A laboratory information management system (LIMS) may also be provided with the database to provide further integration and unification of data acquired in any given screening campaign or in multiple screening campaigns. Alternatively, there may be provided an interface for exchanging data with an external LIMS.

Information services module 406 is a subsystem that provides software services allowing the communication between users and the system 400. Users of the orchestrated laboratory system 100 and the software system 400 may include researchers, scientists, laboratory personnel, facility staff and facility managers. Information services module 406 is responsible for providing a user interface, such as a graphical user interface, to allow users to communicate with the system. The user interface may be accessible remotely, no matter where a user is located. Such user interfaces may be provided, for example, by Web-browser-based software applications, software applications resident on either a fixed or wireless mobile networked computing device, or a display terminal directly controlled by information services module 406. Input can be entered by a user through the user interface. Information services module 406 can request data from data warehouse 404 and present the data in a suitable format for user review. Status information, such as progress of experiments, can be sent to users as system messages or may be communicated to users on display terminal 118 or information portal 122. Information services module 406 may further distinguish the types of data and their respective intended user and present the data differently so as to tailor the portal presentation specific to users' particular roles within a laboratory. For example, information regarding status of various instruments, including assays being run on instruments or workstations, may be delivered to users by network messaging module 402 on information portal 122, without any restriction. On the other hand, test plans and modifications thereof may be delivered to scientists in a trusted fashion, requiring user authentication.

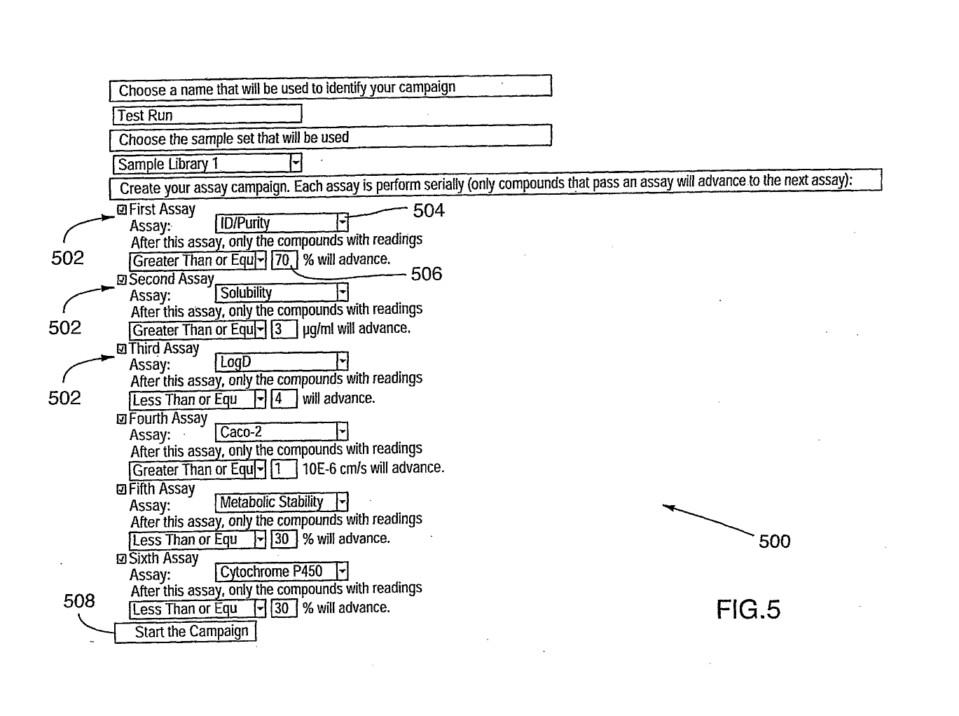

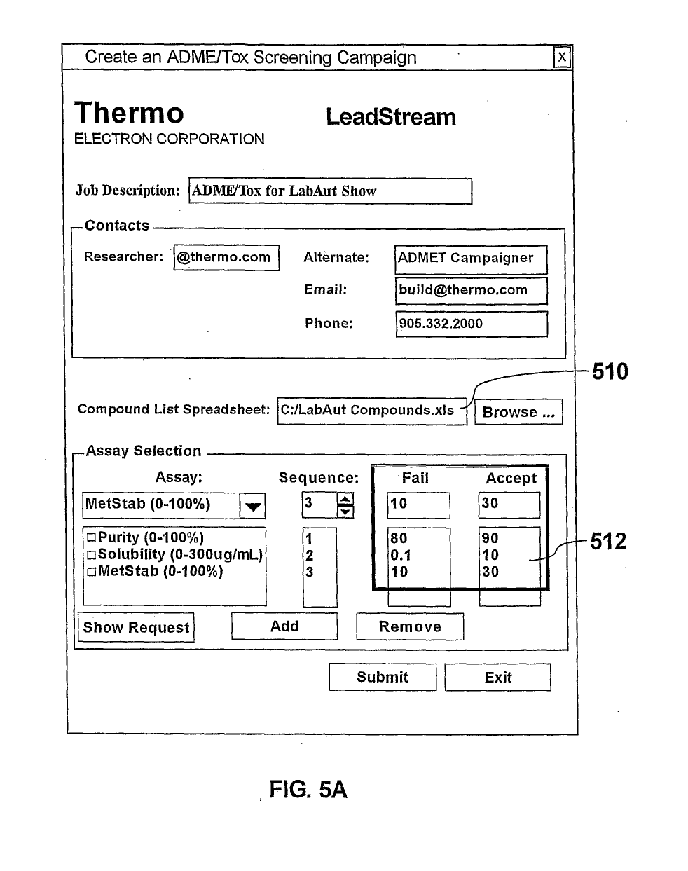

FIG. 5 shows one example of a data entry form produced by information services module 406. This data entry form may be presented to a user as a web page formatted on a display terminal 118. This way, a user can access the system any time and from any location. The data entry form can be used by a user, such as a researcher, to define a job request, in this case, a compound screening campaign. A user starts by providing a list of compounds to be tested. The user also identifies the tests to be conducted on each sample. Each assay is associated with specific experimental procedures, which may be either provided by the user or established by the testing facility. FIG. 5 shows a series of assays to be run in a screening campaign. As will be appreciated, a screening campaign serves to identify compounds that possess certain pre-selected properties. A test acceptance criteria, or hurdle property, is assigned to, or associated with each assay. Through the data entry form, the user can associate with each assay a single test acceptance criteria, a number of test acceptance criteria, or an acceptable range or ranges, for determining whether the compound passes or fails the assay. The user may pick the order in which each assay is run, for example, in order of priority. Alternatively, the user may specify interdependencies of the assays, in which case, the software system 400 determines a sequence to run the assays. The user may also specify a condition to terminate the testing process, for example, when one of the assays fails. These criteria are entered into the system and saved to data warehouse 404 as a test plan.

The entry form 500 shown in FIG. 5 allows a user to define a series of assays that need to be run in sequence. Appropriate hurdle rates for each assay can be selected. In this example, six selectable assay entry cells 502 are provided (with the first three being labeled). A user can select, for example, from a drop-down list 504 in each assay entry cell a desired assay or manually enter an assay to be conducted. A test acceptance criteria is selected or entered in the acceptance criteria box 506. After test acceptance Criteria for the desired number of assays are entered, the user can request the system 400 to schedule the screening campaign by pressing a “Start the Campaign” button 508, or using other suitable means. Process integration server 124 uses the information provided by the user in this user request to schedule and coordinate the tests or assays on each of the compounds as requested by the user.

Although FIG. 5 shows only test acceptance criteria as “hurdles”, test acceptance criteria may also be a range or ranges. FIG. 5A shows another exemplary screen display that allows a user to submit a job request. The user requests three assays to be performed on a list of compounds specified in a compound list data file 510. Instead of a single “hurdle”, a user can specify an acceptance range 512 for each assay. If the test result of a compound falls within the specified range, the compound passes the test. Otherwise, the compound fails.

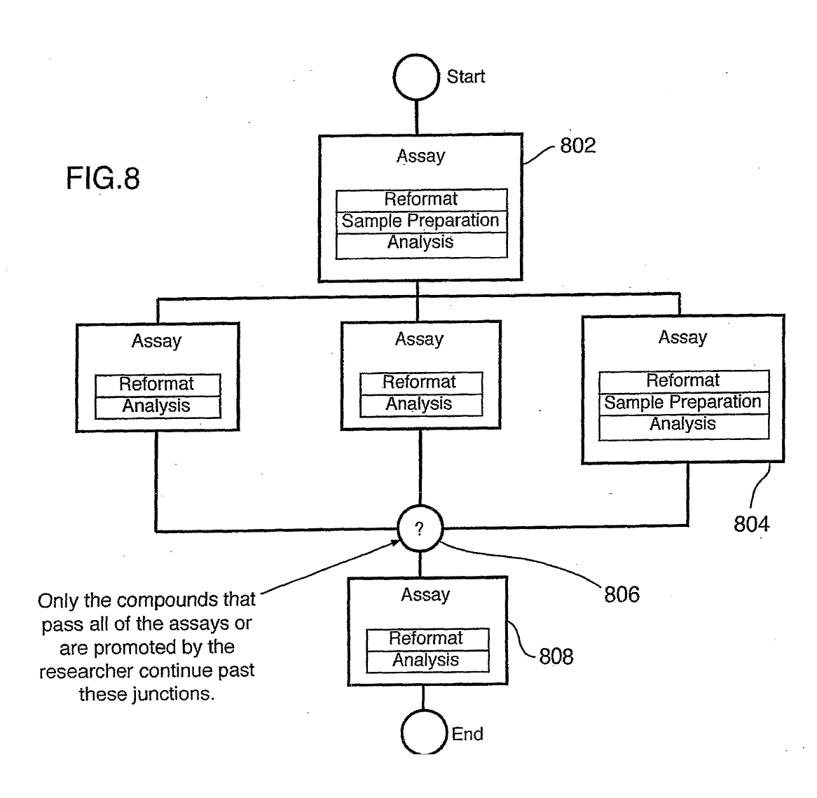

Through similar user interfaces, a user can also define or specify a test strategy for testing the compounds specified. This can be achieved through specifying interdependencies of the assays to be conducted. For example, the user can specify a sequence or order to perform the assays, as shown in FIGS. 5 and 5A. One assay is conducted only after the completion of prior assays in the sequence. The user can also explicitly specify that these assays are all to be conducted in parallel or request parallel testing by specifying that the assays are all independent of each other. A test strategy can include any combinations of serial or parallel testing. The user can also specify a branching relationship between assays, i.e., wherein the test result of an assay determines the subsequent assay(s) to be performed on a compound. For example, the user may specify that one subsequent assay is to be performed only if the result of the current assay is within a particular range and another subsequent assay will be performed instead if the result of the current assay is outside the range. The user, of course, can also define a test strategy that includes a hierarchy or decision tree, combining parallel, serial and branching decisions. An example of a test strategy is shown in FIG. 8, which will be described later.

Referring to an embodiment of the invention as shown in FIG. 4, corresponding to each hardware unit, such as reformatter 108, assay station 110, and analyzer station 112, there is an instrument cell subsystem 410. The hardware instrument cell and its software instrument cell subsystem together constitute a laboratory instrument subsystem. Each laboratory instrument subsystem may operate independently at the instrument level, controlled by its own automation software subsystem. These laboratory instrument subsystems communicate with the process integration server 124 through the network messaging module 402 so that information at each laboratory instrument subsystem, such as instrument status, test conditions, test results, sample information, can be communicated or transmitted to the integration server 124 and any instructions from the process integration server 124 to any of the laboratory instrument subsystems can be similarly transmitted.

The software portion, namely, instrument cell subsystem 410, controls and monitors the operation of the corresponding hardware unit and is responsible for the automated operation, or “walk-away” operation, of each hardware unit. An experiment is set up by supplying the required samples and the requisite instructions on experimental procedures to be carried out. This allows instructions to be sent to the required laboratory resource to start a test procedure. Once a procedure is started, the instrument cell subsystem 410 is responsible for directing the corresponding hardware instrument to carry out the steps without human intervention.

Acquisition of experiment data can be automated. A hardware instrument may be provided with its own dedicated detection units and data acquisition software. The software application may be executing on a processor physically located in the vicinity of the hardware unit, or may be executing on a processor remote from the hardware unit, such as a central computer located in a control room. The hardware unit may also be serviced by a generic software application that is designed for servicing all hardware units operated by a laboratory. Instrument cell subsystem 410 may also be responsible for capturing data from the experiment or samples, if the hardware instrument is not equipped with its data acquisition software.

FIG. 4 shows the details of one embodiment of an instrument cell subsystem 410 for a reformatter, namely the reformatter subsystem 412. The reformatter subsystem 412 has a robotic control module 414 for controlling at least one of the robotic device, such as a robot arm 128, a liquid handling module 416 for controlling the liquid handling devices, namely liquid handler 132, and a laboratory process module 418 for performing laboratory processes, such as controlling sample temperature or labeling and sealing sample containers. Where an identification means, such as a bar code reader, is provided; laboratory process module 418 is also responsible for “checking in” and “checking out” sample plates and thereby enabling the system 100 to track the movement of each of the sample plates within the system.

Instrument cell subsystems for other instrument cells may have a similar structure, although it will be appreciated that the function of each instrument cell subsystem will vary. For other types of workcells, other software modules may be required. For example, for an analyzer station 112, there will be a data acquisition module. If the analyzer station 112 has its own dedicated data acquisition software application, the data acquisition module will only be responsible for interfacing the dedicated data acquisition software application with process integration server 124; otherwise, the data acquisition module will also be responsible for interacting with data acquisition devices of the analyzer station 112 to capture data and transmit the captured data to integration server 124.

Process scheduler 408 is a software service subsystem that applies laboratory experiment rules to the construction of a laboratory workflow strategy. A scientist or researcher submits a user request to the system 400 through a user interface provided by the system 400. The user request generally includes a test plan, which includes a list of one or more samples to be tested as well as an indication of one or more assays or analyses (i.e., tests) to be conducted on each sample. The test plan may also include a test strategy. The user can specify a test strategy to conduct tests in parallel, in serial, or in a combination thereof. Branching conditions can also be specified. The scheduler 408 analyzes the test plan and determines an order of running all assays in the specified set of assays. An example of a test strategy is provided in FIG. 8, as will be described in detail later.

Alternatively, test strategy may be implicitly specified through interdependencies and priorities of the assays. For example, for a process screening for desirable pharmaceutical components, it may be desirable to run all toxic assays first. Any compound that fails a toxic assay may be rejected immediately. The process scheduler 408 may schedule to run all toxic assays in parallel and as the first step in a series of tests.

Running one assay may require a series of steps such as reformatting samples, conducting experiments on the samples, and analyzing experimental results to capture data. Laboratory resources required for each step of an assay as well as time required are generally known in advance. This information may be stored in a memory means accessible to scheduler 408 or in a permanent storage device, such as a hard disk. Based on the assays requested by a user, the scheduler 408 may also develop a list of required instrument units, as well as the required laboratory personnel, for performing the tests.

Decision module 420 is a software service subsystem that examines information obtained from laboratory instrument subsystems, by way of their software service components or instrument cell subsystem 410 provided by process integration server 124. Decision module 420 applies heuristics to the determination of adjustments to subsequent laboratory process flows orchestrated with the process integration server 124.

For example, a user can specify a test acceptance criteria, or “hurdle property”, for “promoting” a sample to the next scheduled assay. Failing a single test acceptance criteria may eliminate a compound immediately, without the need of continuing with other assays. Other heuristic methods can be used, such as passing control samples (such as test markers or “canaries”) through to subsequent tests, or basing the hurdle rate on the capacity of the downstream devices. A test acceptance criteria may also be cumulative in that only after failing a number of similar hurdle properties will the compound be eliminated. The decision module 420 can make the decision automatically to determine whether to permit the compound to proceed (or, to be “promoted”) to the next assay. This allows the automatic running of all assays once the samples are provided to the system 100. Alternatively, the researcher can choose to be advised on the status of each test so that a decision can be made on the hurdle property while the results are being reported (as described further below).

Workflow interface subsystem 422 is a subsystem that provides software services allowing laboratory personnel and research scientists to interact with the system, monitor the process of each experiment, monitor the status of the laboratory instruments, and initiate, modify or execute laboratory processes. To the extent that some elements of the orchestrated laboratory flow process are performed by laboratory personnel, and not laboratory instrument subsystems, inherent in such a configuration is the communication with such personnel by the orchestration components and the process integration server, during the course of initiating, adjusting, and executing the laboratory process. The communication may be in the form of e-mail messages, notification messages on a computer display, status indication displayed in a message window, an audio message or any other suitable form.

Once an assay is completed for a compound, the decision module 420 of the software system 400 makes a decision as to whether the compound should be promoted. A message is then sent to the laboratory resources scheduled for the next step. The next step may be further compound detection, other experiments, or sample preparation, for example. If the hardware resource for the next step is completely automated, the message may be in the form of a control signal to commence operation of the hardware unit. If the hardware resource for the next step is not completely automated, the message may be an e-mail message sent to a laboratory technician or a test facility staff responsible for the hardware unit so that that person may take the necessary steps to commence the operation of the hardware unit to start the next step. In case where the compound is not promoted, there may not be any further steps to be performed on the compound. This helps to reduce the number of unnecessary testing and thereby speed up the screening process.

Results analysis module 424 provides the necessary data analysis services and is part of the data processing module 114. Data generated by hardware units and acquired by their associated data acquisition software applications are analyzed by the results analysis module 424. Results analysis module 424 typically has a statistics component for extracting statistical information from raw data. It may also have graphing components for visually presenting data. Data may be analyzed as the experiment is being conducted, for example, by periodically polling the hardware instrument for new data, or upon completion of the experiment. Results analysis module 424 may also process data in real-time and provide feed-back to the hardware unit for optimizing compound detection and data acquisition. For example, results analysis module 424 may analyze data streams from a LC-MS workstation, locate signal peaks, and provide feed-back to the LC-MS workstation so the detection parameters may be optimized in real-time. Results analysis module 424 may be custom programmed for those specific experiments conducted in a laboratory, or may be adapted from commercially available data analysis software. Results analysis module 424 may also make experiment results available to users, laboratory personnel, or others for viewing and process decision-making.

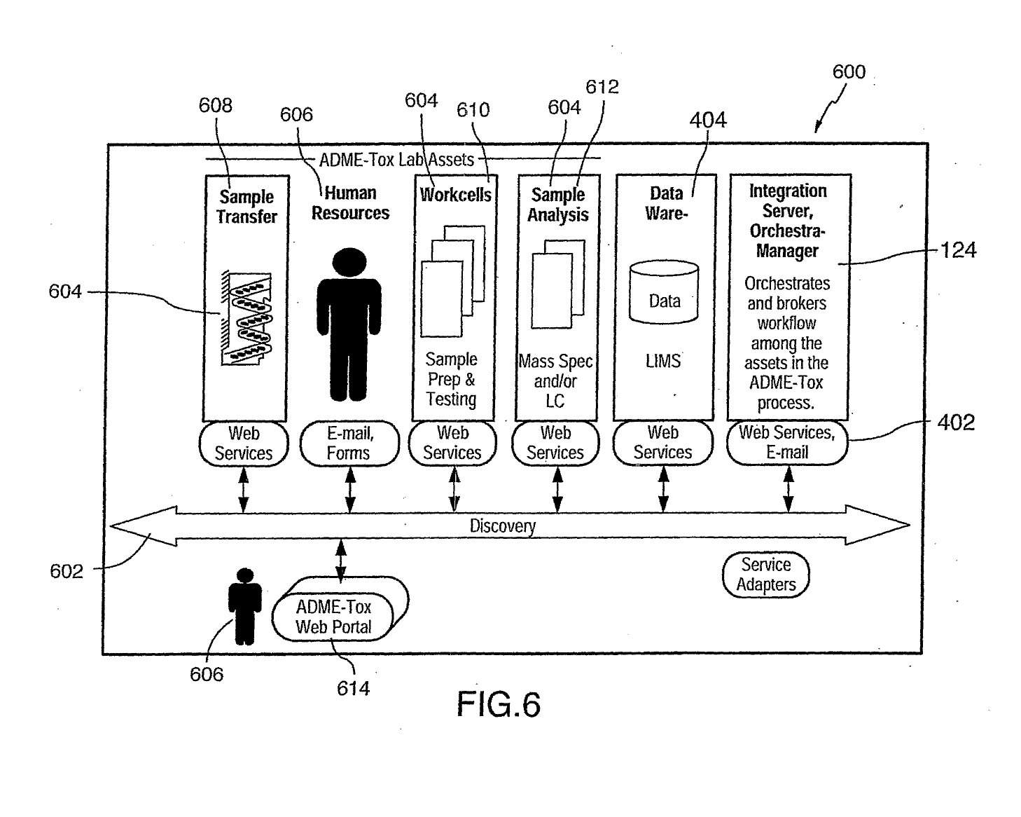

In another embodiment, orchestration software system 400 interconnects experiment instruments to support an orchestrated testing environment 600 as illustrated in FIG. 6. Central to this environment is interchange hub 602, or discovery bus, which comprises an interchange over which all the elements of orchestrated testing environment 600 interrelate and which helps create a communication environment in which people, hardware instrumentation and software applications interact. The bus is logical or conceptual, rather than a physical bus such as a computer's bus or a telecommunication network. For example, in an orchestrated laboratory system, the bus may represent LANs and protocols, with which computer systems communicate. The bus may also represent messaging to and from laboratory personnel. In general, messages are sent to interchange hub 602 for the intended recipient to pick up and act upon. The bus is a link within the orchestrated testing environment 600 that allows each elements of the environment to communicate with other elements.

Each self-contained, automated laboratory instrument, such as the reformatter, work cell etc., constitutes an individual laboratory service process. Laboratory instruments 604 interacts with each other and other elements in the orchestrated testing environment 600 through interchange hub 602. For example, laboratory personnel 606 interact with process integration server 124 through interchange hub 602 in the form of e-mail messages and data entry forms. Network messaging module 402 enables the initiation and completion of test procedures conducted by workcells, such as sample transfer 608, sample preparation and testing 610 and sample analysis 612. Communication may be in the form of web messages delivered to interchange hub 602, which messages are then processed by process integration server 124 and delivered to their respective destinations for further processing. A web portal 614 (or a display terminal, not shown in FIG. 6) is attached to interchange hub 602 for allowing a user, laboratory personnel, or others to monitor the progress of experiments. A user may also use web portal 614 to access the system to control the progress of the experiments, such as to pass or fail a compound for a particular assay, or series of assays based on results received from the system.

Orchestration software system 400 interconnects the individual laboratory instruments to provide an integrated laboratory environment 600. The laboratory process flow is determined and adjusted by the process integration server 124 according to data received from individual laboratory instrument systems. These data are obtained as these systems perform their assigned test procedures following the process flow.

The environment 600 may be supported by custom software. Conveniently, commercially available software also may be used, with only necessary custom programming to integrate the commercially available software. For example, BizTalk™ commercially available from Microsoft Corporation may be used to perform some of the functions required by process integration server 124 or workflow interface subsystem 422.

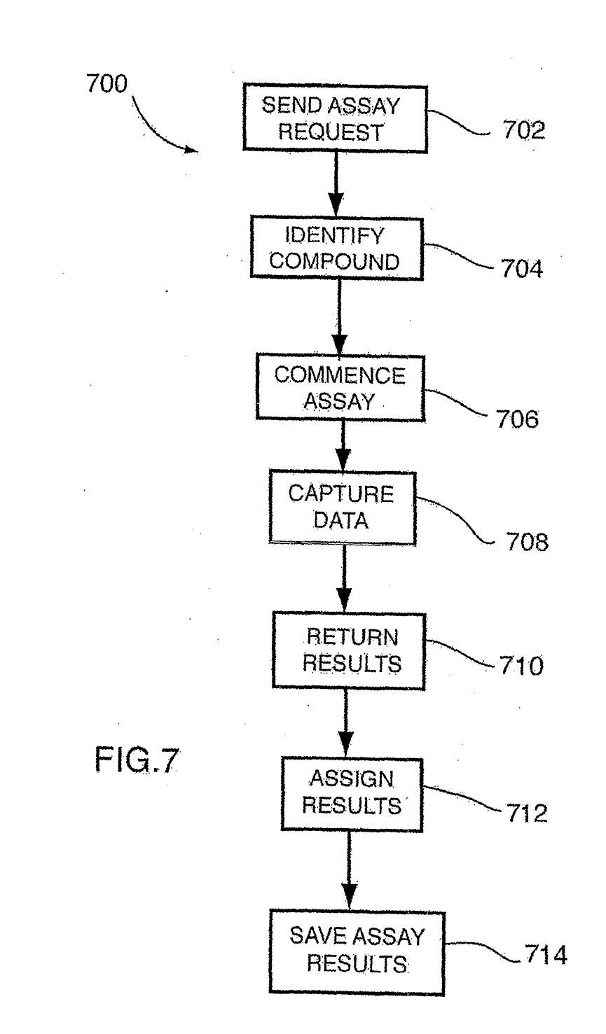

FIG. 7 provides an example of a laboratory workflow. Here, a laboratory workflow refers to the flow of samples and data through the orchestrated laboratory system 100 as well as human interaction with the samples and data. The workflow 700 shown in FIG. 7 may include, for example, the steps of sending and receiving an assay request 702, identifying a compound 704, commencing an assay 706, capturing data 708, returning assay results 710, assigning assay results 712, and saving assay results 714.

At the step of sending and receiving assay request 702, a laboratory staff member, for example, starts the workflow by sending an operation request. The request may also be sent automatically by the system. For example, when samples are delivered to a workcell, such as an LC-MS workstation for purity assay, upon checking in of the samples using a barcode reader, an XML form is sent from the LC-MS workstation and received by process integration server 124. The process integration server 124 uses the message to identify the compound to be tested at the step of identifying compound 704 and the assay requested in order to schedule and instruct the appropriate workcell for performing the assay. At the step of commencing assay 706, a message (for example, in XML format) is sent to an appropriate hardware unit, such as assay station 110 to commence the requested assay. Data is captured during the performance of the assay at the step of capturing data 708 where possible. Certain data may only be collected upon completion of experiment. When all data are collected, assay results are returned from the hardware units to process integration server at a step of returning assay results 710. The returned assay results are assigned to the compound, namely associated with the compound, at the assigning assay results 712 step. The assay results, associated with the compound, are next stored in data warehouse 404 for later retrieval or further processing. Once such a generic workflow is defined, it may be repeatedly executed by the hardware and software components of the orchestrated laboratory system 100.

Referring to FIG. 8, running assays in a combination of parallel and serial steps is described using the exemplary process shown. A total of five assays are shown. In this example, successful completion of first assay 802 determines whether to run the rest of the assays. The next group, second, third and fourth assays 804, are independent of each other and therefore are run in parallel. Running assays in parallel helps to maximize utilization of hardware resources such as workcells and instruments and reduce their idle time. Upon completion of second, third and fourth assays 804, results of each assay are evaluated to determine whether to promote all or only some of the samples. At decision point 806, such decision may be made by the system or by a user. Only the samples that pass all the assays, namely first assay 802 at the first serial step and second, third and fourth assays 804 at the parallel step, will be “promoted” to the next serial step i.e., advance to the next step for the fifth assay 808. If a compound is not to be advanced as determined by the system, preferably, the system sends a message to the user and requests the user to review the decision. The user can either confirm or override the decision.

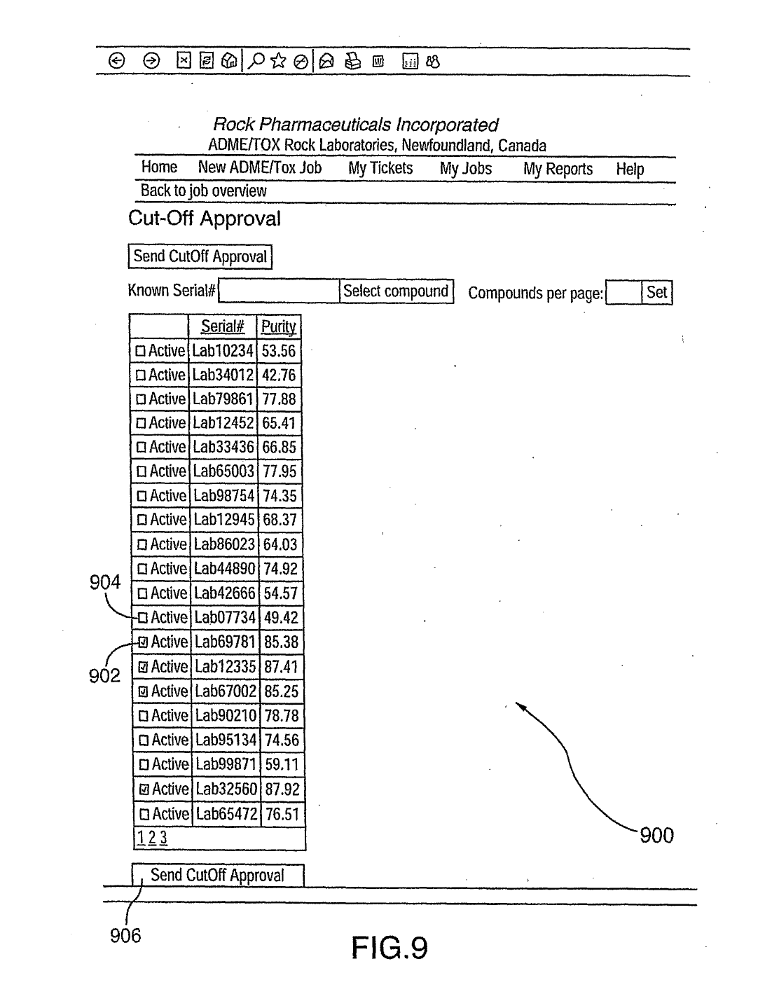

FIG. 9 shows an exemplary screen display 900 from which the user may enter or modify a decision as to whether to pass a compound for a purity assay. The exemplary screen display 900 shows the purity results for a number of compounds. Each compound sample has a designated compound serial number so the system can track and store results of each assay on each compound sample. The test acceptance criteria, i.e., test cut-off, in this case is set at 80%. From exemplary screen display 900, it can be seen that several compounds have passed the assay, as indicated by a checked checkbox 902 shown next to the corresponding serial number. Others have unchecked checkbox 904, indicating that the compounds failed the assay. The system 400 makes the initial decision whether a compound passes an assay based on the test acceptance criteria associated with the assay. A compound having the checkbox checked passes and will advance to the next assay. A compound having its checkbox unchecked may not advance to the next assay. If the test plan specifies that a compound will be eliminated immediately upon failing the assay, the unchecked compound will be eliminated from all subsequent assays. If the test plan specifies that a compound will be eliminated if it fails certain number of assays or a set of specified assays, the decision module 420 will determine whether the compound has failed the pre-determined number of assays or all of the assays in the specified set and decide whether to eliminate the compound from further screening. However, preferably, the system 400 sends a notification message to a user and requests the user to review and confirm the system decision. The user may access the system through information portal 122, for example. A web page that is shown in FIG. 9 can be provided. The user may uncheck a checked checkbox 902 or check an unchecked checkbox 904 to override the system decision. After a user is satisfied which compounds should pass or fail the assay, the user press the confirmation button 906 labeled “Send CutOff Approval” to confirm the system decision or to commit the changes just made.

In operation, a user submits a user request for running a number of assays on a list of compounds to the system 100 through a user interface. Optionally, the scheduler 408 analyzes the user request to generate an order to run these assays on each of the compounds. Upon confirmation or notification that compound samples are arrived at the laboratory, instructions are sent to the reformatter 108 to reformat plates, namely, to create a sublibrary from the library of samples, for conducting the first assay. The status of the laboratory resources and each sample as well as the data generated from the tests are monitored and stored. At the completion of each assay conducted on each sample, the decision module 420 may compare test results with a test acceptance criterion, if one is supplied by the user. If the test results are within acceptable range as compared with the test acceptance criterion, the compound being tested is to be “promoted”, i.e., to be further tested. If so, instructions are sent to reformatter to reformat the compound for the next assay. Otherwise, a message may be sent to the user so the user can determine whether the compound is to be to promoted. These steps are repeated until all compounds specified in the user requests are tested.

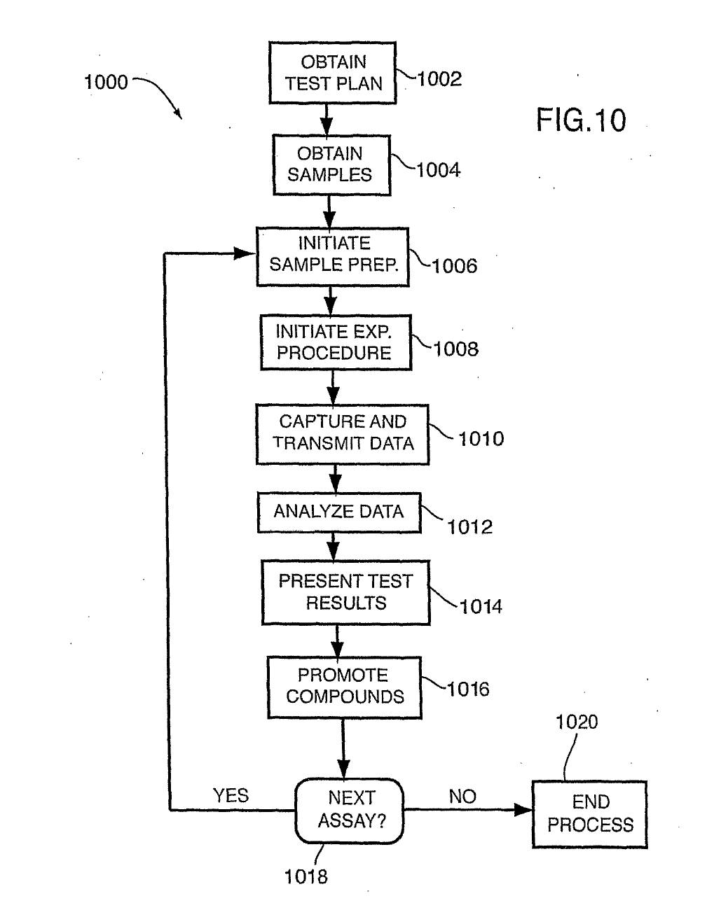

Referring to FIG. 10, there is shown a diagram in flowchart format an orchestrated laboratory process 1000. This represents a process for screening compounds from a list of compounds. This process implements dynamic scheduling. Instead of scheduling all assays in advance, this process schedules each assay only as necessary, namely only if the assay is to be conducted on the compound, depending on results of prior assays requested by the user.

The process has the following steps: obtaining test plan 1002, obtaining samples 1004, initiating sample preparation 1006, initiating experiment procedures 1008, data acquisition 1010, performing data analysis 1012, optionally presenting test results 1014 to a user of the system, deciding compounds promotion 1016, making subsequent assay decision 1018, and process termination 1020.

The process starts by obtaining a test plan related to the screening campaign at an obtaining test plan 1002 step. The test plan may be one entered by a user in the user request, or modified from a previous test plan. As described earlier, a test plan identifies a list of samples or compounds, a set of assays for each compound and optionally a test strategy. The test strategy may request that the assays be run in parallel, in serial, in a combination of parallel or serial, or including branching conditions. Test procedures and experiment protocols may also be defined or specified. The test plan is retrieved at the obtaining test plan 1002 step.

When determining next the samples of compounds required, the scheduler 408 analyses the test plan (or test plans if there are more than one user request outstanding), and determines an order to conduct the assays. As will be appreciated, if a sequential order is provided in the test plan, the integration server 124 simply follows the order in scheduling the assays. Once an assay to be performed is determined, the required compounds or samples can also be determined by identifying all samples for the assay from the test plan or plans. In general, if a decision tree is specified, the decision tree provides an order to conduct the assays. If no order is specified, or if at one stage, parallel testing is requested, then these assays can be performed in parallel, namely, performed in any time sequence. If not sufficient hardware units are available for testing all samples, a round robin order, or any other suitable order, may be selected by the system for parallel testing. In any case, the system will first select an assay for testing, based on the test strategy, or decision tree, provided in the user request, namely the test plan. If a priority is specified, assays having the same priority are scheduled together, starting from the highest priority. Optionally, the system may also poll the required hardware units or examine the schedule information of the required hardware unit to determine whether all these hardware units required for conducting the chosen assay will be available. If any of them will not be available when required, the system may attempt to schedule next assay until an assay can be scheduled. As described above, once the chosen assay is determined, samples are selected and provided to reformatter 108.

Referring to FIG. 10, having retrieved a pre-defined test plan, the system 400, at an obtaining samples 1004 step, confirms that samples have arrived and placed in one of reformatter 108. Samples may be selected from a master library and placed in reformatter 108 by laboratory personnel for creating a sublibrary. Alternatively, samples can be selected by robotic devices and transported to reformatter 108 automatically. Selected samples may be identified by labeling means such as barcode labeling the compound in the master library and the samples or plates holding the samples. Where only plate labeling is labeled, sample in each well of the plate can be mapped to the compound selected from the master library for identification and tracking purposes.

Upon confirmation that samples are in reformatter 108, process integration server 124 sends a web service message to the instrument cell subsystem 410 responsible for reformatter 108. The instrument cell subsystem 410 instructs reformatter 108 or a laboratory technician to start the reformatter 108 to prepare sample plates for the requested assays at an initiating sample preparation 1006 step. Reformatter 108, through its instrument cell subsystem 410, informs process integration server 124 when sample preparation is completed. In a semi-automated system, process integration server 124 sends an e-mail message to laboratory personnel, updates the status information presented in information portal 122, or otherwise notifies the laboratory technician of the completion of sample preparation so that the laboratory technician may transport the prepared samples to assay station 110 for testing. If barcode or other labeling technology is used, a bar code reader may be employed to check in and check out the samples. Process integration server 124 may then record the location of each sample, thus providing location tracking of each of the samples as they move from hardware unit to hardware unit. In an automated system, process integration server 124 directs a transport system to move the prepared samples from reformatter 108 to assay station 110 and records the movement and location of each sample.

Experiments are conducted at assay station 110. An instrument cell subsystem 410 responsible for assay station 110 is instructed by process integration server 124 to start the experiments at an initiating experiment procedures 1008 step. Experiment procedures specified in the test plan or steps in the protocol selected for the test plan are followed by instruments and devices of assay station 110, such as robotic devices and liquid handling devices, in an automated fashion. Upon completion of all procedures, the instrument cell subsystem 410 notifies process integration server 124 by sending a notification message, for example. Again, in a semi-automated system, process integration server 124 may notify a laboratory technician or a researcher of the completion of the experiment by sending an e-mail message, updating the status information presented in information portal 122, or by employing some other suitable means. The e-mail message may simply provide status information. It may also include an experiment report to provide more detailed information about the assay or experiment completed. Any other suitable audio or visual means may be utilized to provide the notification.

As described earlier, dedicated software or instrument cell subsystem 410 responsible for a workcell captures experiment results and transmits the captured data to process integration server 124 for saving to data warehouse 404. Data acquisition 1010 is performed either when the experiment procedures are being conducted or at the conclusion of the experiment procedures, depending on the nature of assay and the experiment procedures. Once the results are captured, they are stored in data warehouse 404.

Next, process integration server 124 waits for results from analytics module 424. The results analysis module 424 polls the hardware units periodically for new data. Once a hardware unit has new data available, in a data analysis 1012 step, the results analysis module 424 processes the raw data and extracts information from the data. Data analysis operations may include statistical analysis of the data, formatting data, i.e., manipulating for sharing with other components of the system or other users, as well as preparing data for visualization. Results of data analysis 1012 are also stored in data warehouse 404 as the data are processed.

At the step of presenting test results 1014, these results are communicated to users, such as researchers and laboratory personnel. The results may be “pushed” to the users by updating a status screen display constantly as results of each assay become available; they may also be “pulled” by users as a response to request for data or assay results. As will be appreciated, because the test results are communicated back to the integration server 124 in real time, or at least during each assay, what are available to users and therefore can be communicated to users are not limited to test results. As the test results are stored for each sample at least during each assay, the storing of test results therefore enables the system to provide status information to the user in real time. Along with the test result, test conditions of each experiment, such as temperature or agitation rate, can be stored. The status information therefore may include the assays already conducted on the sample and assays still left to be conducted, the test results of conducted assays, and test conditions of the conducted assays, among others.

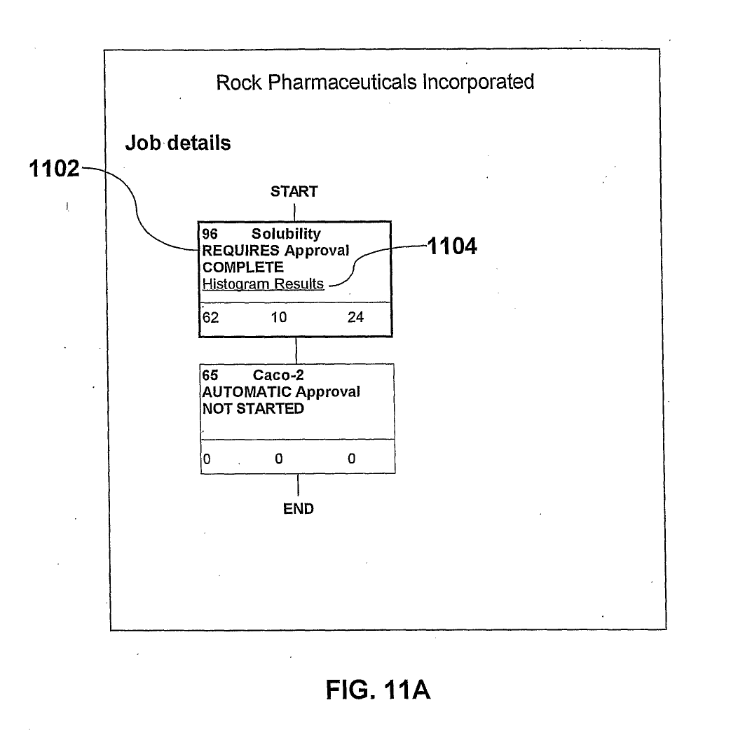

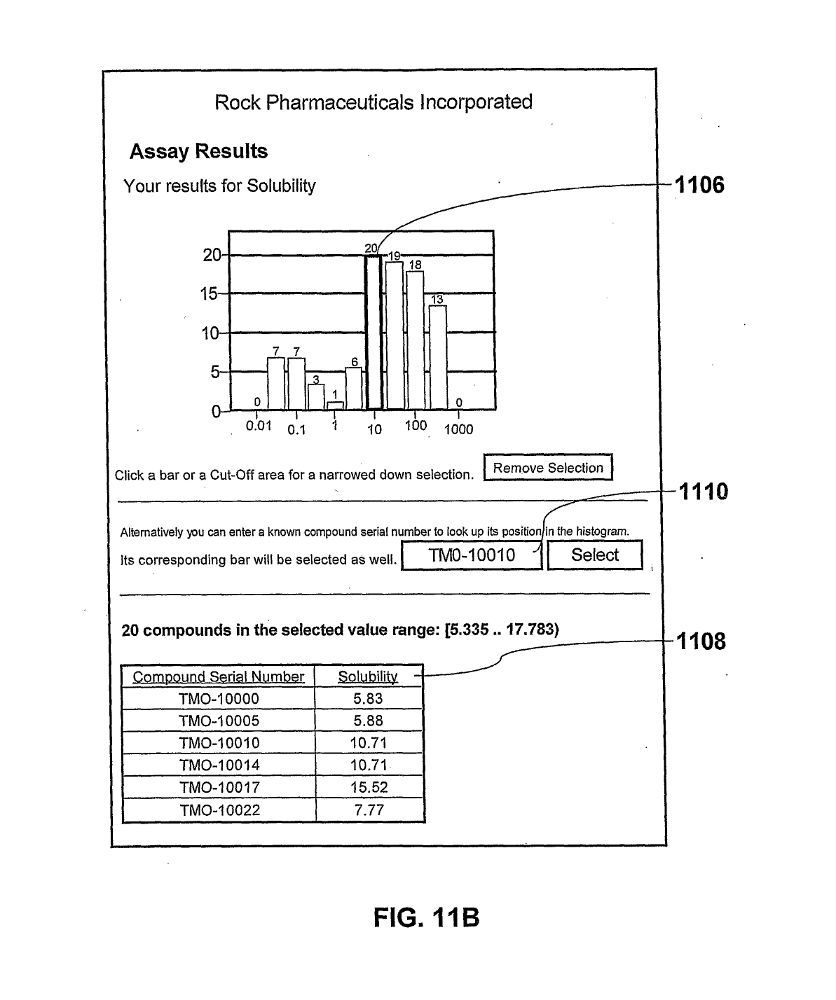

At this step, status information can be communicated to a user as requested, or constantly communicated to the user as the information is updated. Because of the potentially large quantity of information associated with such a screening process, the information can be organized and presented in a summary form, and in a graphical format. For example, the results and status of the tests can be shown in a flow chart format, corresponding to the decision tree specified by the user, as that shown in FIG. 11A. FIG. 11A is an exemplary screen display that provides detailed status and summary information related to a user request. This process has only two assays specified. The screen display shows that the first one is completed, and the second one is yet to start. The result box 1102 provides a summary of total number of compounds tested, the number of compounds that pass the test and the number of compounds that fail the test. It also provides hot links, or actuatable areas, for a user to drill down, namely to request more detailed information. For example, by selecting the actuatable area 1104 labelled “Histogram Results”, the user can request another screen that shows the test results in greater detail. This is shown in an exemplary screen display shown in FIG. 11B. As can be seen in FIG. 11B, compounds are grouped by their results. Graphed in each range in a pre-determined series of ranges are compounds with test results falling in the range. Any particular group or range can be further examined. FIG. 11B shows that one group 1106 is selected for further examination. The group has solubility falling within the pre-determined range [5.335, 17.783). As can be seen, 20 compounds have a solubility within this range. Each compound, represented by a unique compound serial number, has its solubility shown in the result column 1108. Test results of a particular compound can also be selected and reviewed, for example, by entering its compound serial number in an input area 1110. As will be understood, although only test results are shown in this exemplary screen display, other status information can be similarly presented and displayed. Further drill-down, namely, selecting a graphical element representing a group of samples or a sample to further explore the data at a more detailed level, may be similarly provided. This allows a user to track the compounds as they are tested, including the tracking of their physical locations as they move from hardware unit to hardware unit and their experiment status within the process, including the assays conducted and the results of each assay.

At compounds promotion 1016 step, process integration server 124 retrieves the results of the assay and forward the results to its decision module 420. At least the relevant test acceptance criteria for the assay is also forwarded to or made available to decision module 420. The decision module 420 compares the assay results with the test acceptance criteria to determine whether to advance all, some or none of the compounds. A sample is to advance if its test results pass the associated test acceptance criteria. An advanced compound will have further assays performed thereon until all assays requested by the user have been completed.

If the test results fail the test acceptance criteria, the sample may be eliminated from further testing. In general, a sample is eliminated from further testing if it fails a specified set of tests. A special case is for the sample to fail a single test. As discussed earlier, in general, the decision to eliminate a sample is made accumulatively on the failure of several tests. The controlling factor may be the number of failed tests in the specified set of tests or the failure of all tests in a more confined group. How the accumulative decision is to be made is specified by a user, such as a scientist, when submitting a job request entry form. If a sample is not to be promoted, no further tests will be performed on the failed sample. The sample can be removed from the schedule for further testing. If so, none of the hardware components that are scheduled to perform further tests on the failed sample will be requested to perform the cancelled tests. Alternatively, a message may be sent to all such hardware components to explicitly cancel further testing, or to all staff members who would otherwise test the failed sample as scheduled. This tends to reduce the wasted time and resources spent unnecessarily on samples that are already known to be unsuitable.

Whatever the decision is rendered by the software system 400, the decision may be reviewed and modified by a user. For example, when screening for compounds, a user may review the results of current assay or all assays performed thus far and then decide whether to fail a compound. Test results as well as test acceptance criteria may be reviewed along with the machine-made decision. The results may be provided through a user interface, such as an information portal 122. The user may confirm the automatically rendered decision. The user may also use his or her own judgment to decide whether to modify, namely manually override, the automatically rendered decision. A user can make these modifications through, for example, a user screen shown in FIG. 9. Alternatively, the user may also modify the test acceptance criteria to indirectly alter the system rendered decision. At the step of deciding subsequent assay 1018, process integration server 124 will terminate the testing process, i.e., screening campaign, at step 1020, unless there is at least one remaining assay to be performed on advanced compounds.

In case a further assay is to be performed, the process returns to the step of obtaining samples 1004 step. Namely, process integration server 124 instructs reformatter 108 to prepare the requisite plates for the next assay, without including any compounds that are already eliminated, and the process will be repeated from there.

As can be seen, according to this process, each assay is scheduled for a compound only if necessary. The scheduling of the assay is dynamic in that the process integration server 124 determines the next step and directs the laboratory resources to start the next assay only when test results of the current assay are known. Because test results are communicated back to the process integration server 124 in real time, the next assay can be scheduled in real time as well, upon the completion of the current assay.

Further, the scheduling can incorporate availability of laboratory resources, including hardware resources and laboratory personnel. In general, it tends to be more difficult to predict when a laboratory resource may become unavailable at the beginning of the testing process, which may last for several days. But, it may be more predictable whether a laboratory resource may become unavailable when the next assay is to be conducted, which may be only several hours in the future. In addition, should a hardware resource becomes unavailable during an assay, dynamic scheduling also allows the screening process to be re-scheduled, instead of suspending the process until the failed hardware resource becomes available again. For example, suppose during a purity assay, an LC-MS workstation breaks down, the integration server 124 can dynamically schedule and start the next assay to be carried out if the next assay does not require an LC-MS workstation, instead of waiting for the current assay to finish. Of course, it is understood that the next assay does not depend on the result of the current assay, though it is also possible to program the integration server 124 to ignore the results of the current assay, if the estimated time for restoring the failed hardware resource exceeds certain limit. Although this example makes reference to hardware failure, it is understood that the same principle can be applied to unavailability of laboratory personnel as well.

At the end of the screening process, the network messaging module 402 may generate a message to notify the user of the termination of the process. As will be understood, the process may terminate either when all requested assays are conducted or when there are no further assays to be conducted. Of course, a user may also decide to terminate the process at any time. The notification may simply inform the user that the process is now terminated so that the user can request a final test report. The system 400 may also generate a test report at the end of the process, without being requested by the user, and send the test report to the user, along with the notification message. The test report may include summary information relating to the screening process, such as number of compounds that pass all test criteria and the test conditions of each assay. Further drill-down on each assay or each compound may also be provided in the test report, for the user to explore further the test results.

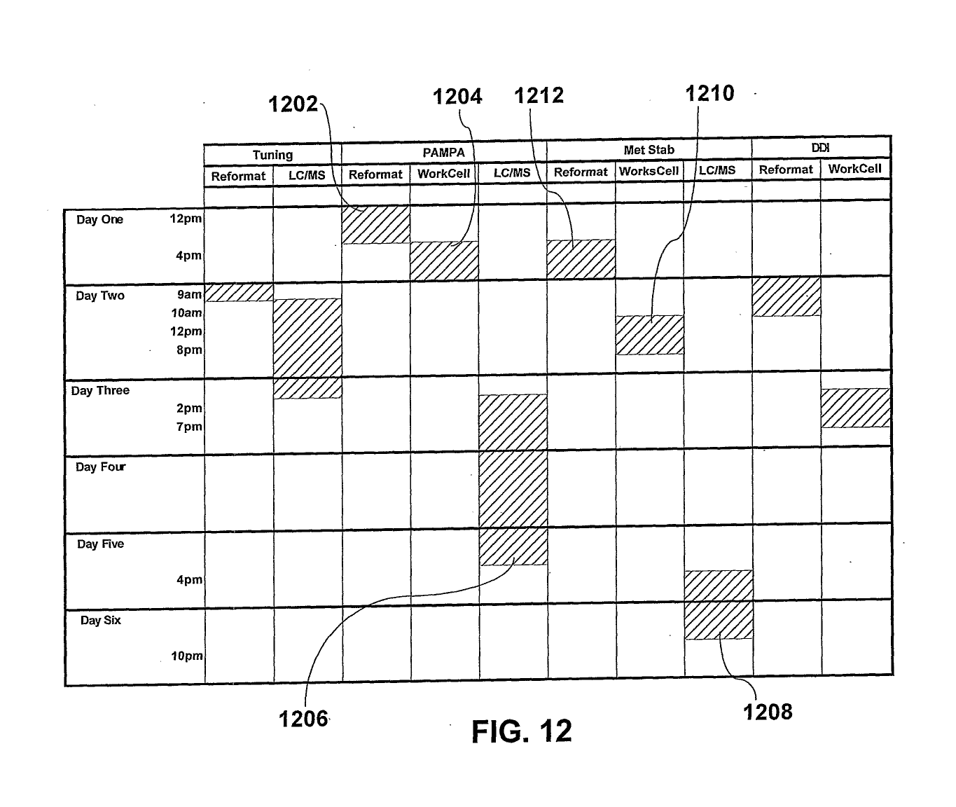

FIG. 12 shows an example of applying the process shown in FIG. 10 to conduct three assays on a few hundred samples. The three assays are metabolic stability (Human microsomes), DDI (CYP 3A4 inhibition) and PAMPA, which are represented by shaded areas in the chart. As can be seen from FIG. 12, the PAMPA assay and MetStab assay require a reformatter, an assay station and an LC-MS station, while the DDI assay require only a reformatter and an assay station. Prior to miming the samples on an LC-MS station, a tuning run, is performed on the LC-MS station to tune the LC-MS station for the compounds being tested. Referring to FIG. 12, these three assays are all run in parallel, without dependencies. The chart shows that the PAMPA assay starts with reformatting (1202). Samples prepared by reformatter are then run on an assay station (1204), after which the samples are analyzed on an LC-MS station (1206).

As can be seen in FIG. 12, the LC-MS analysis does not begin immediately after the samples finish the tests at the workcell at the end of day one. Instead, the LC-MS analysis (1206) begins at day three. This is due to the tuning run, which makes the LC-MS station unavailable. Similarly, when conducting the MetStab assay, the LC-MS analysis (1208) does not begin immediately after the tests at the workcell (1210) at the end of day two; but rather commences only at day five, when the PAMPA assay has completed its LC-MS analysis operation. These resource conflicts may be planned and resolved in advance, using a project planning software such as Microsoft Project™. Preferably, these conflicts are resolved by process integration server 124 when it orchestrates the operation of each laboratory resources. Through status tracking and monitoring, the process integration server 124 maintains a list of availability of laboratory resources. Prior to directing the required laboratory resources to perform a step in an assay, the process integration server 124 determines the availability of the required laboratory resource(s) and sends a message to initiate the step only when the resource or resources are available. Where the required laboratory resources are able to maintain a job queue, the process integration server 124 may also simply add the instructions to initiate the next test step to the queue so that the laboratory resource may start the next step once it becomes available.

FIG. 12 also shows that reformatting for MetStab (1212) begins before the PAMPA assay finishes. This is an example of progressive reformatting, or dynamic preparation of samples. Through the communication with the process integration server 124, the reformatter 108 is provided with a running list of samples in a continuous stream that have completed the test or passed a test acceptance criteria for the PAMPA assay. As results come in, requests for reformatting these compounds for the subsequent assay is added to the running list. The reformatter 108 can start reformatting the compounds once they are added to the running list. Assay plates are accumulated progressively in separate temporary storage places, or “hotels”, for each of the subsequent assays for the passed, or “promoted”, compounds. Essentially; the reformatter 108 is engaged at a steady rate rather than in bursts of sample preparation. Idle time of hardware components is minimized. Alternatively, progressive reformatting can also be achieved by building assay specific pick lists dynamically at runtime. Compounds, or rather, serial numbers representing the compounds, are added to the pick list upon completion of experiment procedure of each sample. The pick list can be stored temporarily in computer memory or in a more permanent storage medium such as a hard disk to facilitate future review. The pick list is built dynamically, rather than built at the completion of the entire batch of samples. Instead of instructing the reformatter 108 to start preparing plates for the next test in advance for an estimated amount of time, the reformatter 108 also can start reformatting plates for the next assays when the pick list has grown to contain a pre-determined number of compounds. This number can be provided by a user in a test plan or may be set by a laboratory personnel based on instrument capacity, for example. All information on the generation of plates is passed back to the process integration server 124. At the completion of preparation of plates for one of these separate assays, the reformatter 108 notifies the process integration server 124. The process integration server 124 can subsequently notify the laboratories resource scheduled for the assay, either a hardware unit (in a completely automated system) or a laboratory technician (in a semi-automated system), to commence the assay. The time the assay is commenced can be stored in data warehouse 404, to allow users to track the status of the assay and the screening process in real time.

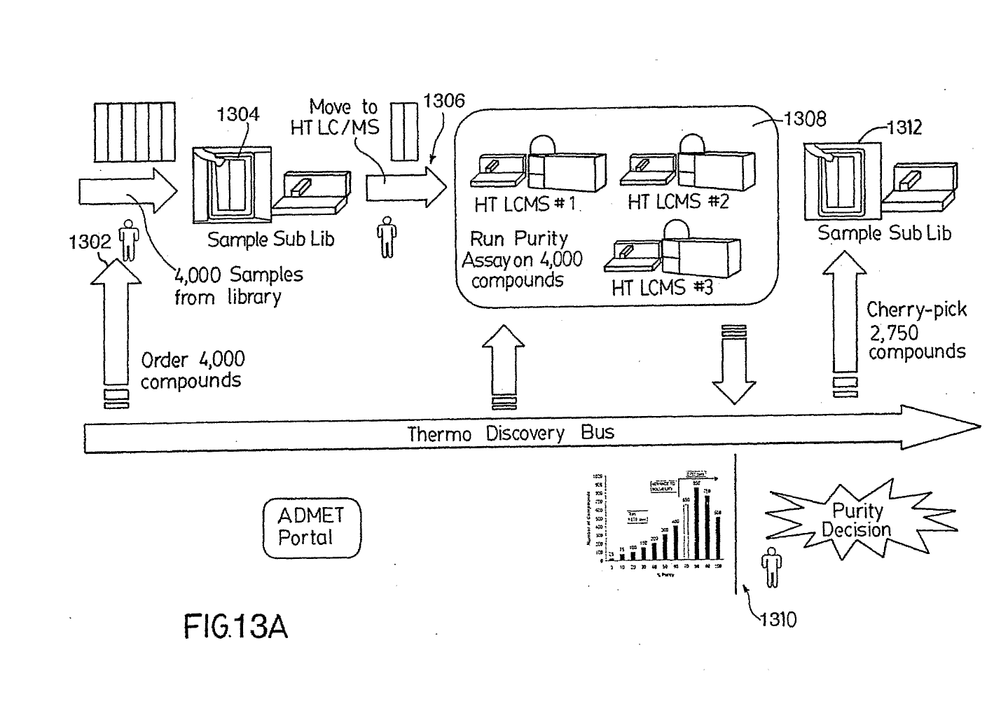

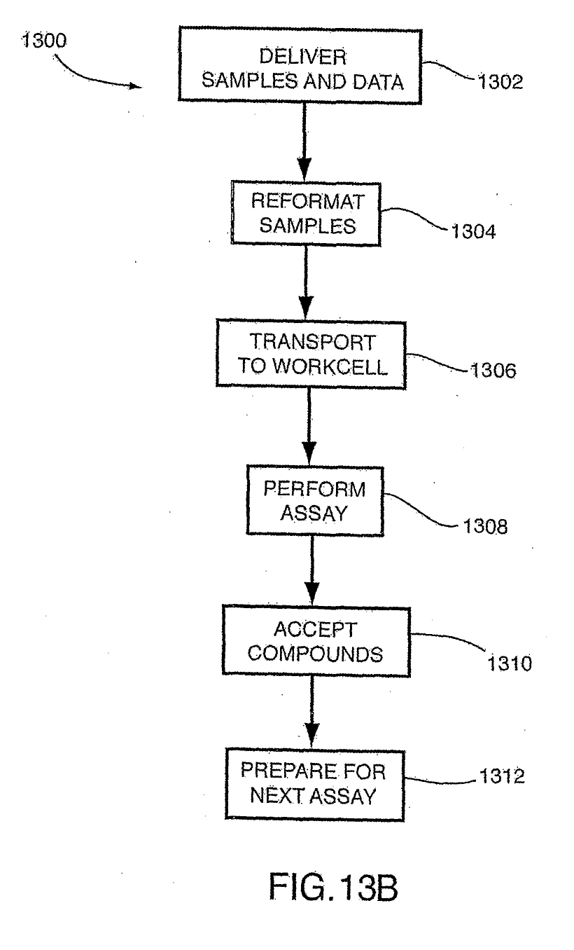

In one embodiment, a process alternative to that shown in FIG. 10 is implemented to screen compounds, namely to perform multiple assays on each candidate compound identified in a list of compounds. FIG. 13A illustrates schematically the steps of a process for performing an assay as seen in the orchestrated testing environment 600 shown in FIG. 6; FIG. 13B shows steps of the process in a flowchart format.

The steps are as follows. First, at step 1302, the compounds from a library to be screened are delivered to the orchestrated laboratory system 100, in a set of formatted microtitre plates, together with the data corresponding to each of the compounds. Next, at step 1304, reformatter 108 reformats these samples into the appropriate microtitre plates to form a sublibrary of samples. At step 1306, reformatted samples are transported to the appropriate workcell or workstations for performing the assay, either by a robotic transport device or moved by a laboratory technician.

The purity assay commences at step 1308. As purity data is being obtained, decisions will start to be made on whether a compound passes the property hurdle or not at step 1310. As described, the system 400 can decide whether to advance a compound for further testing by comparing assay results against the associated test acceptance criteria. Scientists can review the system decision to advance or eliminate a compound, and to confirm or override the decision, or vary the hurdle rates, or choose other heuristics to indirectly decide whether to pass compounds to the next stage.

If at least one compound passes the property hurdle, the system 400 at step 1310 automatically starts passing information on to the reformatter 108, through the process integration server 124, in order to start reformatting microtitre plates for the subsequent assay. The reformatter 108 reformats all the passed compounds into new microtitre plates as directed. If the next assay is not immediately performed upon creation of the sublibrary, the plates are stored in standard format container temporarily, waiting to be tested.

Various embodiments of the invention have now been described in detail. Those skilled in the art will appreciate that numerous modifications, adaptations and variations may be made to the embodiments without departing from the scope of the invention. Since changes in and or additions to the above-described best mode may be made without departing from the nature, spirit or scope of the invention, the invention is not to be limited to those details but only by the appended claims.

1. A system for orchestrating laboratory functions performed by laboratory resources on samples to be tested, the laboratory resources comprising at least one of hardware resource and a laboratory operator, the laboratory resources being able to perform said laboratory functions upon receipt of instructions messages, the system comprising:
a user interface for receiving one or more requests from users, each of said requests identifying one or more tests to be conducted on at least one of said samples;
a sample preparation station for creating a sublibrary of said samples, the sublibrary comprising those samples for which a test selected from said tests is to be conducted,
a process server for directing the sample preparation station to initiate sublibrary creation and for directing a laboratory resource to perform the selected test, the process server comprising:
a means for monitoring status of the laboratory resource and location and status of the sublibrary,
a message module for providing communication between the process server and at least one of the laboratory resource, the user interface, and the sample preparation station, and
a control module for directing the message module to send an initiation message to the laboratory resource to initiate said selected test.

2. The system of claim 1, wherein the at least one or more requests identify at least said selected test and a second test and wherein the process server is configured to direct the sample preparation station to create a second sublibrary for said second test and configured to direct the sample preparation station to create a second sublibrary for said second test and configured to direct a second laboratory resource to perform said second test, when the laboratory resource selected to perform said selected test becomes unavailable.

3. The system of claim 1, wherein the process server is configured to send a message to at a laboratory operator when the sample preparation station completes the creation of said sublibrary.

4. The system of claim 1, wherein one or more of said requests include a test acceptance criteria associated with at least one of the tests, and wherein the process server further comprises a decision module for comparing a test result of one sample of the sublibrary with the associated test acceptance criteria to determine whether the test result meets the associated test acceptance criteria.

5. The system of claim 4, wherein the process server is configured to receive the test result and to send a reformatting message to the sample preparation station to add the one sample to another sublibrary upon the test result meeting the associated test acceptance criteria, said another sublibrary being created for another of said tests where said one or more requests identify at least two tests.

6. The system of claim 5, wherein the process server is configured to send the reformatting message in real time.

7. The system of claim 4, further comprising a memory means for storing a reference to the one sample that has the test result meeting the associated test acceptance criteria, wherein the process server is configured to send a reformatting message to the sample preparation station to create another sublibrary when the memory means has a pre-determined number of said references stored therein, said another sublibrary including the pre-determined number of samples, the test results of the pre-determined number of samples meeting the associated test acceptance criteria.

8. The system of claim 1, wherein the tests identified in said requests are provided with interdependencies, said interdependencies comprising a hierarchical structure, a parallel relationship, a sequential relationship, a branching relationship, and a combination thereof, and the system further comprising:
a scheduler for generating an order to run said tests, said order being generated from said interdependencies.

9. The system of claim 1, further comprising a memory means for storing status information, said status information being chosen from the group comprising the status of the laboratory resource, the location of the sublibrary, the location and status of the samples contained in the sublibrary, the status of the sublibrary, test conditions and test results of each sample of the sublibrary.

10. A computer based method of orchestrating laboratory functions performed by laboratory resources on samples to be tested, the laboratory resources comprising at least one of hardware resource and a laboratory operator, the laboratory resources being able to perform said laboratory functions upon receipt of instructions messages, the method comprising the steps of:
receiving a library of samples,
receiving one or more requests from users, each of said requests identifying one or more tests to be conducted on at least one of said samples from said library,
creating a sublibrary of said samples, the sublibrary comprising those samples from said library for which a test selected from said tests is to be conducted,
sending an initiation message to a laboratory resource to initiate said selected test, and
providing results of said selected test to users requesting said selected test.

11. The method of claim 10, wherein one or more of said requests include a test acceptance criteria associated with at least one of the tests, the method further comprising the steps of:
receiving from the laboratory resource a test result of one sample of the sublibrary, and
comparing the test result with the associated test acceptance criteria to determine whether the test result meets the associated test acceptance criteria.

12. The method of claim 11, further comprising the steps of, upon the test result meeting the associated test acceptance criteria,
adding the one sample to a second sublibrary, said second library being created for another of said tests where said one or more requests identify at least two tests.

13. The method of claim 11, further comprising the steps of, upon the test result meeting the associated test acceptance criteria,
in a loop, storing a reference to said one sample until a pre-determined number of references to said samples are stored, the test results of said pre-determined number of samples meeting the associated test acceptance criteria,
creating a second sublibrary including said pre-determined number of samples for another of said tests, and
sending another initiation message to another laboratory resource to initiate said another test.

14. The method of claim 10, wherein the tests identified in said requests are provided with interdependencies, said interdependencies comprising a hierarchical structure, a parallel relationship, a sequential relationship, a branching relationship, and a combination thereof, and the method further comprising the step of:
generating an order to run said tests, said order being generated from said interdependencies.

15. The method of claim 10, further comprising the step of tracking and monitoring the status of the laboratory resource acid location and status of the sublibrary and the samples contained therein.

16. The method of claim 15, wherein the at least one or more requests identify at least said selected test and a second test and the method further comprising the steps of, upon the laboratory resource becoming unavailable:
creating a second sublibrary, said second sublibrary comprising samples for which said second test is to be conducted, and
sending a second initiation message to a second laboratory resource to initiate said second test.

17. The method of claim 10, further comprising the step of notifying a user upon termination of a request of the requests received from the user.

18. The method of claim 10, further comprising the steps of generating a test report upon termination of a request of the requests received from a user and communicating said test report to the user.

19. The method of claim 10, further comprising the step of providing a request of said one or more requests to a user for review.

20. The method of claim 19, further comprising the steps of receiving a modification request from the user and modifying the requested tests on a sample according to the modification request
